(19) United States
(12) Patent Application Publication
(10) Pub. No.: US 2017/0298245 A1
(43) Pub. Date: Oct. 19, 2017

(54) CERAMIC INK FOR INKJET PRINTING

(71) Applicant: ZSCHIMMER & SCHWARZ CERAMCO S.P.A., Sassuolo (IT)

(72) Inventors: Roberto FERRARI, Castellarano (IT); Andrea GUERRA, Modena (IT); Roland SCHICK, Lahnstein (DE)

(73) Assignee: ZSCHIMMER & SCHWARZ CERAMCO S.P.A., Sassuolo (IT)

(21) Appl. No.: 15/511,788

(22) PCT Filed: Sep. 17, 2015
(86) PCT No.: PCT/EP2015/071363

§ 371 Date: Mar. 16, 2017

(30) Foreign Application Priority Data
Sep. 19, 2014 (IT) MO2014A000269

(51) Int. Cl. C09D 11/322; C09D 11/033; C04B 41/83; C09D 11/38; C09D 11/107

(52) U.S. Cl. CPC C09D 11/322; C09D 11/38; C09D 11/107; C04B 41/83; C09D 11/033; C04B 2235/9661

(57) ABSTRACT

A ceramic ink for inkjet printing, comprising: one or more inorganic pigments, distilled, double-distilled or demineralized water, one or more polar organic solvents, one or more dispersants, one or more antifoaming surfactants and optionally one or more preservatives/bactericidal agents, in defined quantities.

The present invention relates to a ceramic ink for graphic decoration of ceramic articles by inkjet printing.

In the field of ceramic decoration, inks for graphic decoration allow to create the pattern on a ceramic substrate, replacing traditional decoration provided by screen printing or by roller with laser etching (intaglio method). In particular, inks for graphic decoration by inkjet printing based on organic solvents, both polar and non-polar, are known. The use of water as a solvent is not considered in known inks in the prior art. This fact is dictated by the particularities of decoration on ceramics, which generally occurs on the hot ceramic article: due to its low boiling point, when the ink is applied the water would evaporate rapidly from it, thus altering its physical and rheological characteristics.

The aim of the present invention is to provide an ink for graphic decoration of ceramic substrates that has a reduced content of polar organic solvents with respect to traditional inks.

Within this aim, an object of the invention is to provide a water-based ink for decorating ceramic substrates by means of inkjet printers.

Another object of the invention is to provide an ink for decorating ceramic substrates that facilitates the yield of ceramic colors.

Another object of the invention is to provide an ink for decorating ceramic substrates that limits the phenomenon of water-repellency of the applications of glaze after the ceramic decoration proper.

Another object of the invention is to provide a method for preparing a ceramic ink that has a reduced content of polar organic solvents.

Another object of the present invention is to provide the use of a ceramic ink having a reduced content of polar organic solvents for graphic decoration of ceramic substrates.

Another object of the invention is to provide a ceramic ink that has good rheological characteristics for decoration on ceramic substrates, is relatively easy to provide and at competitive costs.

This aim, these objects and others which will become better apparent hereinafter are achieved by a ceramic ink for inkjet printing, comprising:

(i) 15 to 60% by weight with respect to the total weight of the ink of one or more inorganic pigments;

(ii) 5 to 80% by weight with respect to the total weight of the ink of distilled, double-distilled or demineralized water;

(iii) 5 to 80% by weight with respect to the total weight of the ink of one or more polar organic solvents selected from the group consisting of glycerol, glycerol ethoxylate with 2 to 20 moles of ethylene oxide per mole of glycerol, monoethylene glycol, diethylene glycol, triethylene glycol, tetraethylene glycol, polyethylene glycols with a molecular weight comprised between 200 and 4,000 Da, monopropylene glycol, dipropylene glycol, tripropylene glycol, polypropylene glycols with a molecular weight comprised between 200 and 4,000 Da, propylene glycol methyl ether and isomers thereof, dipropylene glycol methyl ether and isomers thereof, tripropylene glycol methyl ether and isomers thereof, diethylene glycol monoethyl ether, diethylene glycol dimethyl ether, triethylene glycol dimethyl ether, methyl diglycol, methyl triglycol, butyl glycol, butyl diglycol and butyl polyglycol;

(iv) 0.1 to 15% by weight with respect to the total weight of the ink of one or more dispersants selected from the group consisting of: polyacrylate polymers and derivatives thereof with a molecular weight comprised between 1000 and 100,000 Da, polyurethane polymers and derivatives thereof, acrylate/maleate copolymers and derivatives thereof with a molecular weight comprised between 1000 and 100,000 Da, resins based on styrene/maleic anhydride (SMA), alkylene polyphosphone esters, phosphoric acid esters, salts of carboxylic or hydrocarboxylic acids and derivatives thereof, esters of carboxylic or hydrocarboxylic acids and derivatives thereof, amide polyesters and derivatives thereof;

(v) 0.01 to 1% by weight with respect to the total weight of the ink of one or more antifoaming surfactants selected from the group consisting of: block copolymers of ethylene oxide/propylene oxide, pure and/or emulsified silanes, pure and/or emulsified siloxanes, pure and/or emulsified fatty acids and esters thereof;

(vi) 0 to 0.5% by weight with respect to the total weight of the ink of one or more preservatives/bactericidal agents selected from the group consisting of methylisothiazolinone (MIT) and derivatives thereof, chloromethylisothiazolinone (CIT) and derivatives thereof, benzisothiazolinone (BIT) and derivatives thereof, and organic molecules that release formaldehyde.

The aim and objects of the invention are also achieved by a method for preparing the ceramic ink according to the invention, comprising the steps of:

(a) preparing a mixture of distilled, double-distilled or demineralized water and one or more polar organic solvents selected from the group consisting of glycerol, glycerol ethoxylate with 2 to 20 moles of ethylene oxide per mole of glycerol, monoethylene glycol, diethylene glycol, triethylene glycol, tetraethylene glycol, polyethylene glycols with a molecular weight comprised between 200 and 4,000 Da, monopropylene glycol, dipropylene glycol, tripropylene glycol, polypropylene glycols with a molecular weight comprised between 200 and 4,000 Da, propylene glycol methyl ether and isomers thereof, dipropylene glycol methyl ether and isomers thereof, tripropylene glycol methyl ether and isomers thereof, diethylene glycol monoethyl ether, diethylene glycol dimethyl ether, triethylene glycol dimethyl ether, methyl diglycol, methyl triglycol, butyl glycol, butyl diglycol and butyl polyglycol;

(b) adding to the mixture obtained in step (a): (i) one or more dispersants selected from the group consisting of: polyacrylate polymers and derivatives thereof with a molecular weight comprised between 1000 and 100,000 Da, polyurethane polymers and derivatives thereof, acrylate/maleate copolymers and derivatives thereof with a molecular weight comprised between 1000 and 100,000 Da, resins based on styrene/maleic anhydride (SMA), alkylene polyphosphone esters, phosphoric acid esters, salts of carboxylic or hydrocarboxylic acids and derivatives thereof, esters of carboxylic or hydrocarboxylic acids and derivatives thereof, amide polyesters and derivatives thereof; (ii) one or more antifoaming surfactants selected from the group consisting of: block copolymers of ethylene oxide/propylene oxide, pure and/or emulsified silanes, pure and/or emulsified siloxanes, pure and/or emulsified fatty acids and esters thereof; and optionally (iii) one or more preservatives/bactericidal agents selected from the group consisting of methylisothiazolinone (MIT) and derivatives thereof, chloromethylisothiazolinone (CIT) and derivatives thereof, benzisothiazolinone (BIT) and derivatives thereof and organic molecules that release formaldehyde;

(c) adding to the mixture obtained in step (b) one or more inorganic pigments, obtaining a dispersion;

(d) milling the inorganic pigments by treating the dispersion obtained in step (c) with a grinding mill;

(e) filtering the dispersion obtained in step (d).

The aim and objects of the invention are further achieved by the use of the ceramic ink according to the invention to decorate ceramic articles by inkjet printing.

Further characteristics and advantages will become better apparent from the detailed description that follows. Furthermore, the ink according to the present invention, the method for preparing it and its use offer a considerable series of advantages and benefits, which will be discussed hereinafter.

The technology of ceramic decoration always provides for a thermal process for “firing” the article after its decoration. Therefore, reducing the content of organic solvents present in the ink for graphic decoration, replacing part of it with water, allows to limit the quantity of organic substances released into the flue: in the firing process the water simply becomes vapor, while a smaller quantity of organic solvents undergoes a process of oxidation to carbon dioxide and water. The ceramic ink according to the invention, therefore, by having a smaller quantity of organic solvents than known inks, offers an unquestionable advantage from an environmental standpoint. On average, the ceramic ink according to the invention allows to reduce by approximately 50% the organic chemical components with respect to commonly commercially available inks based on organic solvents, with a consequent 50% reduction of pollutant emissions originating both from the oxidation of the organic solvents during firing of the ceramic articles and from the processes for the production of such solvents. In other words, thanks to the ink described herein it is possible to reduce by 50% the organic chemical components intended for combustion during the firing of ceramic articles, with a consequent 50% reduction of the emission of burnt or partially burnt carbon-based products. Furthermore, the emission of combustion products with a low olfactory threshold is also reduced during ceramics firing.

The presence of water in the ink according to the invention also makes its production process more effective and less polluting, reducing the emission of pollutants with respect to the production of traditional inks. Moreover, the water-based ink according to the invention allows to avoid the use of washing solvents (so-called cleaners), which cannot be recovered but have to be disposed appropriately. Systems for the production of water-based ink can be washed with water, which can then be treated and recovered. Washing and maintenance of printers for ceramic decoration filled with the ink according to the invention can use polar cleaners that mostly contain water and can then be discharged directly into wastewater.

With respect to commonly used organic solvent-based inks, the water-based ink described here is a considerable innovation in terms of printed ceramic decoration technology. First of all, the use of the water-based ink during decoration prevents the phenomenon of water-repellence of the applications of glaze that occur after decoration. This avoids the need to resort to the use of compatibility promoting additives in order to avoid the formation of flaws caused by water-repellency during glazing, after printed decoration. Ceramic products decorated with the ink according to the invention further have in general fewer defects. With respect to traditional inks based on organic solvents, the water-based ink according to the invention in fact reduces the formation of surface flaws caused by the combustion of the organic chemical components. Moreover, in some cases, a high content of organic substances within the ink causes color yield flaws. The low content of organic chemical components in the ink described herein can instead facilitate the development of ceramic colors, improving the quality of the decorated product.

Finally, the water-based ink according to the invention is also advantageous from the point of view of practical use. For example, the outer parts of printers loaded with the ink according to the invention and the adjacent part contaminated by the ink can be cleaned or washed simply with water or with a cloth moistened with water: therefore, it is not necessary to use any type of organic solvent inside the printer enclosure. Moreover, the tanks that contain the ink according to the invention can be washed with water and reused or recovered by means of the disposal of plastic waste without requiring any particular disposal. Furthermore, the water-based ink is fully compatible with the water vapor that forms under the print heads inside the printers.

In view of the above, it is evident that the advantages and technical improvements ensured by the ink according to the invention consequently lead also to advantages in economic terms linked to the reduction, throughout the production line, of the energy used, of pollutant emissions, of waste produced and of the use of washing solvents.

An aspect of the present invention relates therefore to a water-based ceramic ink for inkjet printing.

Within the context of the invention, the expressions “ceramic ink”, “water ink” and “water-based ink” are used interchangeably to indicate the ink described herein. The expression “solvent-based”, referred to traditional inks known in the prior art, references organic solvents.

In the context of the present invention, the expression “one or more polar organic solvents” indicates that the ink can comprise a plurality of polar organic solvents, both belonging to the same chemical type (e.g. multiple polyethylene glycols with different molecular weight) and belonging to different chemical types (e.g., glycerol and dipropylene glycol). Likewise, the expression “one or more dispersants” indicates that the ink can contain a plurality of dispersants, both belonging to the same chemical type (e.g., multiple polyacrylate polymers with different molecular weight) and belonging to different chemical types (e.g., polyacrylate polymers and resins based on styrene/maleic anhydride). Moreover, the expression “one or more antifoaming surfactants” indicates that the ink can comprise a plurality of antifoaming surfactants, both belonging to the same chemical type (e.g., multiple block copolymers of ethylene oxide/propylene oxide) and belonging to different chemical types (e.g., block copolymers of ethylene/propylene oxide and siloxanes).

The ink according to the present invention allows to provide graphic decorations by inkjet printing on ceramic substrates of various kinds. Preferably, the inkjet printing can be of the digital type.

In the ink according to the invention, the inorganic pigments ensure the chromatic effect to the ceramic article painted with it, after the firing step. The inorganic pigments can be chromophorous metallic inorganic oxides, such as for example chromium oxide(III), cerium oxide, zirconium oxide. As an alternative, the inorganic pigments can be compounds such as for example praseodymium zirconium yellow (Cas: 68187-15-5; Einecs: 269-075-7); cobalt chromite spinel (Cas: 68187-11-1; Einecs: 269-072-0); cobalt silicate blue (Cas: 68187-40-6; Einecs: 269-093-5); cobalt aluminate blue spinel (Cas: 1345-16-0; Einecs: 310-193-6); zinc iron chromite brown spinel (Cas: 68186-88-9; Einecs: 269-050-0); chromium iron manganese brown spinel (Cas: 68555-06-6; Einecs: 271-411-2); chromium cobalt iron black spinel (Cas: 68186-97-0; Einecs: 269-060-5); nickel iron chromite black spinel (Cas: 71631-15-7; Einecs: 275-738-1); sphene chromium tin pink (Cas: 68187-12-2; Einecs: 269-073-6); zirconium iron pink (Cas: 68412-79-3; Einecs: 270-210-7); cadmium selenium encapsulated red (Cas: 102184-95-2; Einecs: 310-077-5); zirconium vanadium blue (Cas: 68186-95-8; Einecs: 269-057-9); cobalt chromite green spinel (Cas: 68187-49-5; Einecs: 269-101-7), vanadium bismuthate.

Furthermore, the ink according to the invention can also comprise one or more organic pigments: said organic pigments act as a tracer or dye in order to highlight the deposition of the ink on the ceramic article during pre-firing (unfired) if the ink used comprises inorganic pigments that have a faint color.

In one preferred embodiment of the ink according to the invention, the one or more polar organic solvents can be polyethylene glycols with a molecular weight comprised between 200 and 800 Da, polypropylene glycols with a molecular weight comprised between 200 and 800 Da, or mixtures thereof.

In the ink described herein, the dispersants can be salts or esters of carboxylic or hydrocarboxylic acids; in one embodiment, the carboxylic or hydrocarboxylic acids can be aliphatic, such as for example lactic acid, citric acid, succinic acid. In another embodiment, the carboxylic or hydrocarboxylic acids can be aromatic, such as for example salicylic acid. In a preferred embodiment of the ink, the one or more dispersants can be polyacrylate polymers, alkylene polyphosphone esters or mixtures thereof.

The one or more antifoaming surfactants can be preferably block copolymers of ethylene oxide/propylene oxide, silanes, siloxanes or mixtures thereof. Silanes and siloxanes are commonly indicated by the expression “silicone surfactants”.

Optionally, the ink can also comprise one or more preservatives/bactericidal agents. These compounds are used generally to preserve the inks, preventing their degradation. Although preservatives/bactericidal agents have no impact on the obtainment of the physical, rheological and technical characteristics of the ink according to the invention, they allow the ink to retain its properties over time. In a preferred embodiment, the preservatives/bactericidal agents can be methylisothiazolinone (MIT) and derivatives thereof, chloromethylisothiazolinone (CIT) and derivatives thereof, benzisothiazolinone (BIT) and derivatives thereof or mixtures thereof. More preferably, the preservatives/bactericidal agents can be MIT, CIT or a MIT/CIT mixture. In another preferred embodiment, the ink can comprise one or more among MIT, CIT, BIT and mixtures thereof and one or more organic molecules that release formaldehyde. By way of example, tetramethylol acetylene diurea (TMAD, Cas: 5395-50-6) and ethylenedioxy dimethanol (EDDM, Cas: 3586-55-8) are mentioned as organic molecules that release formaldehyde.

Preferably, the ink can comprise one or more inorganic pigments in a total quantity comprised between 25 and 50% by weight with respect to the total weight of the ink. More preferably, the inorganic pigments can be present in a total quantity comprised between 30 and 40% by weight with respect to the total weight of the ink.

The ceramic ink of the invention is water-based and comprises distilled, double-distilled or demineralized water. Preferably, the water can be present in a quantity comprised between 20 and 40% by weight with respect to the total weight of the ink. More preferably, the water can be present in a quantity comprised between 25 and 35% by weight with respect to the total weight of the ink.

The ink can comprise preferably one or more polar organic solvents in a total quantity comprised between 5 and 40% by weight with respect to the total weight of the ink. In particular, the total quantity of monoethylene glycol, diethylene glycol and triethylene glycol preferably does not exceed 20% by weight with respect to the total weight of the ink; more preferably, said total quantity can be comprised between 5 and 15% by weight with respect to the total weight of the ink. Likewise, the total quantity of monopropylene glycol, dipropylene glycol and tripropylene glycol preferably does not exceed 20% by weight with respect to the total weight of the ink; more preferably, said total quantity can be comprised between 5 and 15% by weight with respect to the total weight of the ink. Moreover, the total quantity of polyethylene glycols with molecular weight between 200 and 800 Da preferably does not exceed 20% by weight with respect to the total weight of the ink. Likewise, the total quantity of propylene glycols with molecular weight comprised between 200 and 800 Da preferably does not exceed 20% by weight with respect to the total weight of the ink.

Preferably, the one or more dispersants can be present in the ink in a total quantity comprised between 0.1 and 15% by weight with respect to the total weight of the ink. In particular, the total quantity of polyacrylate polymers and derivatives thereof with molecular weight comprised between 1000 and 100,000 Da and of the acrylate/maleate copolymers and derivatives thereof with molecular weight comprised between 1000 and 100,000 Da is preferably comprised between 2 and 5% by weight with respect to the total weight of the ink.

Preferably, the ink can comprise one or more antifoaming surfactants in a total quantity comprised between 0.01 and 0.5% by weight with respect to the total weight of the ink. More preferably, the total quantity of the antifoaming surfactants can be comprised between 0.1 and 0.3% by weight with respect to the total weight of the ink.

As regards the one or more preservatives/bactericidal agents, when they are present in the ink, their total quantity can be comprised between 0.1 and 0.2% by weight with respect to the total weight of the ink.

The ink of the present invention has clearly defined physical and rheological characteristics that allow its application by inkjet printing on ceramic substrates. In particular, the ink described here has a viscosity comprised between 5 and 40 mPa*s, a density comprised between 1000 and 1800 kg/m³ (1000-1800 g/l), a dynamic surface tension comprised between 20*10⁻³ e 50*10⁻³ N/m (20-50 dyn/cm) and a static surface tension comprised between 20*10⁻³ and 50*10⁻³ N/m (20-50 dyn/cm). All the values listed above refer to the operating temperature of the ink during application by inkjet printing: this operating temperature is comprised between 25° C. and 55° C. The values of the physical and rheological parameters cited above are obtained as a consequence of the specific quantities of the components of the ink.

Another aspect of the present invention relates to a method for preparing the water-based ink according to the present invention, which comprises the steps of mixing distilled, double-distilled or demineralized water with one or more polar organic solvents as defined previously; adding one or more dispersants, one or more antifoaming surfactants and, optionally, one or more preservatives/bactericidal agents as defined earlier; adding one or more inorganic pigments, forming a dispersion; milling the inorganic pigments, treating the dispersion with a grinding mill; filtering the dispersion.

The milling step and the subsequent filtration step are needed in order to reduce the particle size of the inorganic pigments in the ink, making it possible to use them in printers. The milling chamber of the mill is preferably made of silicon carbide; moreover, the milling chamber can have a capacity comprised between 2 and 160 liters, preferably comprised between 25 and 60 liters. The mill can use microspheres made of cerium/yttrium with high mechanical strength. The microspheres can have a diameter comprised between 0.2 and 1 mm. Preferably, the milling step for a batch of 500 kg of ink can last between 2 and 48 hours, depending on the type of pigment used. Preferably, moreover, the energy of the mill can be comprised between 0.1 and 10 kW·h per kg of pigments, depending on the type of pigments used. At the end of the milling step, the particle size of the inorganic pigments inside the ink, measured by means of a laser refraction meter with the Mie method, has the following values:

D100=5000 nm;

D90=300-3000 nm;

D50=100-1000 nm;

D10=20-400 nm.

As is known in the field of particle size analysis, D100 is the value below which 100% of the population of solid particles lies, D90 is the value below which 90% of the population of solid particles lies, D50 is the value below which 50% of the population of solid particles lies, and D10 is the value below which 10% of the population of solid particles lies. Within the scope of the present invention, the values of D90, D50 and D10 are provided in the form of numeric ranges, since the specific values vary according to the type of pigment used. Depending on the type of pigment, some specific values of D90, D50 and D10 are for example the following: zinc iron chromium spinel (red/brown):

### D90=673 nm; D50=309 nm; D10=111 nm;

chromium cobalt iron spinel (black):

### D90=697 nm; D50=345 nm; D10=122 nm;

cobalt aluminate spinel (blue):

### D90=702 nm; D50=434 nm; D10=198 nm;

praseodymium zirconium yellow+zinc iron chromium spinel (beige):

### D90=736 nm; D50=358 nm; D10=210 nm.

At the end of the milling step, the ink is subjected to a filtration step. Preferably, the pore size of the filter can be equal to 2000 nm or greater. More preferably, the pore size of the filter can be equal to 2000 nm: these filters in fact allow to retain the particles of inorganic pigments with dimensions larger than 2000 nm, the presence of which would interfere with the use of the ink in the printers. The filters used are of a conventional type, commonly used in the field.

Another aspect of the invention relates to the use of the ceramic ink according to the present invention to decorate, by inkjet printing, ceramic articles of various kinds. Preferably, the ceramic articles decorated with the ink according to the present invention can be tiles, kitchenware, sanitary ceramics and technical ceramics. More particularly, the tiles can be for example unfired tiles, fired tiles, tiles made of stoneware, porcelain stoneware, porous single-firing ceramic, double-fired ceramic, clinker, third-firing and fourth-firing. The kitchenware can be unfired kitchenware and fired kitchenware and comprises household items. Sanitary ceramics comprise for example sanitary fixtures, sinks and washbasins, washtubs, shower trays. The expression “technical ceramics”, used commonly in the field of materials, references materials used for example to provide biomedical prostheses, components for the aerospace sector, mechanical components such as disc brakes and bearings, special coatings used in the field of ballistics and mechanics. In the context of the present invention, the term “ceramic article” or “ceramic material” does not reference a glassy material such as for example glass-ceramics.

Finally, another aspect of the invention is constituted by ceramic articles decorated with the ink according to the present invention. The ceramic articles can be decorated by inkjet printing.

It is to be understood that the characteristics of embodiments described with reference to an aspect of the present invention are to be considered valid also with reference to the other aspects of the invention that are described herein, even if they are not repeated explicitly.

### EXAMPLES

### Example 1: Formulation of a Blue Water-Based Ink

Components and quantities (by weight with respect to the total weight of the ink):

| | |
|---|---|
| Blue pigment (cobalt aluminate spinel) | 30% |
| Water | 30% |
| Ethylene glycol (mono, di, tri) | 19% |
| Polyethylene glycols (MW 200-800) | 9.5% |
| Tripropylene glycol methyl ether | 6% |
| Polyacrylate polymers—acrylate/maleate copolymers | 5% |
| (MW 1000-100,000) | |
| Block copolymers of ethylene oxide/propylene | 0.3% |
| oxide, silicone surfactants (silanes and siloxanes), | |
| fatty acid esters | |
| Preservative/bactericidal agent | 0.2% |

Physical and rheological parameters:

Density=1360 kg/m³ at 25° C.;
Viscosity=13.5 mPa*s at the operating temperature of 45° C.;
Surface tension=28*10⁻³ N/m at the operating temperature of 45° C.

### Example 2: Formulation of a Yellow Water-Based Ink

Components and quantities (by weight with respect to the total weight of the ink):

| | |
|---|---|
| Yellow pigment (zirconium praseodymium) | 30% |
| Water | 31% |
| Ethylene glycol (mono, di, tri) | 17.5% |
| Polyethylene glycols (MW 200-800) | 9% |
| Tripropylene glycol methyl ether | 7% |
| Polyacrylate polymers—acrylate/maleate copolymers | |
| (MW 1000-100,000) | 5% |
| Block copolymers of ethylene oxide/propylene | 0.3% |
| oxide, silicone surfactants (silanes and siloxanes), | |
| fatty acid esters | |
| Preservative/bactericidal agent | 0.2% |

Physical and rheological parameters:

Density=1380 kg/m³ at 25° C.;
Viscosity=14.5 mPa*s at the operating temperature of 35° C.;
Surface tension=28.5*10⁻³ N/m at the operating temperature of 35° C.

In practice it has been found that the ceramic ink for inkjet printing according to the invention fully achieves the intended aim, since by being water-based it allows to reduce the organic solvent content. Accordingly, the ink according to the invention is less polluting and more environment-friendly than known inks of the background art, based on organic solvents, as regards its production process, its use and the cleaning of the instruments that come into contact with it. Moreover, the ink described herein achieves the intended aim since it minimizes the water-repellency of the applications of glaze following the ceramic decoration and improves the yield of the colors used for decoration.

The ceramic ink according to the present invention, the method for preparing it and its use for the decoration of ceramic articles, thus conceived, are susceptible of numerous modifications and variations, all of which are within the scope of the appended claims; all the details may further be replaced with other technically equivalent elements the correspondence of which is known to the person skilled in the art.

The disclosures in Italian Patent Application No. MO2014A000269 from which this application claims priority are incorporated herein by reference.

1-15. (canceled)

16. A ceramic ink for inkjet printing, comprising:
(i) 15 to 60% by weight with respect to the total weight of the ink of one or more inorganic pigments;
(ii) 5 to 80% by weight with respect to the total weight of the ink of distilled, double-distilled or demineralized water;
(iii) 5 to 80% by weight with respect to the total weight of the ink of one or more polar organic solvents selected from the group consisting of glycerol, glycerol ethoxylate with 2 to 20 moles of ethylene oxide per mole of glycerol, monoethylene glycol, diethylene glycol, triethylene glycol, tetraethylene glycol, polyethylene glycols with a molecular weight comprised between 200 and 4,000 Da, monopropylene glycol, dipropylene glycol, tripropylene glycol, polypropylene glycols with a molecular weight comprised between 200 and 4,000 Da, propylene glycol methyl ether and isomers thereof, dipropylene glycol methyl ether and isomers thereof, tripropylene glycol methyl ether and isomers thereof, diethylene glycol monoethyl ether, diethylene glycol dimethyl ether, triethylene glycol dimethyl ether, methyl diglycol, methyl triglycol, butyl glycol, butyl diglycol and butyl polyglycol;
(iv) 0.1 to 15% by weight with respect to the total weight of the ink of one or more dispersants selected from the group consisting of: polyacrylate polymers and derivatives thereof with a molecular weight comprised between 1000 and 100,000 Da, polyurethane polymers and derivatives thereof, acrylate/maleate copolymers and derivatives thereof with a molecular weight comprised between 1000 and 100,000 Da, resins based on styrene/maleic anhydride (SMA), alkylene polyphosphone esters, phosphoric acid esters, salts of carboxylic or hydrocarboxylic acids and derivatives thereof, esters of carboxylic or hydrocarboxylic acids and derivatives thereof, amide polyesters and derivatives thereof;
(v) 0.01 to 1% by weight with respect to the total weight of the ink of one or more antifoaming surfactants selected from the group consisting of: block copolymers of ethylene oxide/propylene oxide, pure and/or emulsified silanes, pure and/or emulsified siloxanes, pure and/or emulsified fatty acids and esters thereof;
(vi) 0 to 0.5% by weight with respect to the total weight of the ink of one or more preservatives/bactericidal agents selected from the group consisting of methylisothiazolinone (MIT) and derivatives thereof, chloromethylisothiazolinone (CIT) and derivatives thereof, benzisothiazolinone (BIT) and derivatives thereof, and organic molecules that release formaldehyde.

17. The ceramic ink according to claim 16, wherein said one or more polar organic solvents are selected from the group consisting of polyethylene glycols with a molecular weight comprised between 200 and 800 Da, polypropylene glycols with a molecular weight comprised between 200 and 800 Da, and mixtures thereof.

18. The ceramic ink according to claim 16, wherein said one or more dispersants are selected from the group consisting of polyacrylate polymers, alkylene polyphosphone esters and mixtures thereof.

19. The ceramic ink according to claim 16, wherein said one or more antifoaming surfactants are selected from the group consisting of block copolymers of ethylene oxide/propylene oxide, silanes, siloxanes and mixtures thereof.

20. The ceramic ink according to claim 16, wherein said one or more preservatives/bactericidal agents are selected from the group consisting of methylisothiazolinone (MIT), chloromethylisothiazolinone (CIT) and mixtures thereof.

21. The ceramic ink according to claim 16, wherein said one or more inorganic pigments are present in a total quantity comprised between 25 and 50% by weight with respect to the total weight of the ink.

22. The ceramic ink according to claim 16, wherein the distilled, double-distilled or demineralized water is present in a quantity comprised between 20 and 40% by weight with respect to the total weight of the ink.

23. The ceramic ink according to claim 16, wherein said one or more polar organic solvents are present in a total quantity comprised between 5 and 40% by weight with respect to the total weight of the ink.

24. The ceramic ink according to claim 16, wherein said one or more dispersants are present in a total quantity comprised between 0.1 and 15% by weight with respect to the total weight of the ink.

25. The ceramic ink according to claim 16, wherein said one or more antifoaming surfactants are present in a total quantity comprised between 0.01 and 0.5% by weight with respect to the total weight of the ink.

26. The ceramic ink according to claim 16, wherein said one or more preservatives/bactericidal agents are present in a total quantity comprised between 0.1 and 0.2% by weight with respect to the total weight of the ink.

27. A method for preparing a ceramic ink according to claim 16, comprising the steps of:
(a) preparing a mixture of distilled, double-distilled or demineralized water and one or more polar organic solvents selected from the group consisting of glycerol, glycerol ethoxylate with 2 to 20 moles of ethylene oxide per mole of glycerol, monoethylene glycol, diethylene glycol, triethylene glycol, tetraethylene glycol, polyethylene glycols with a molecular weight comprised between 200 and 4,000 Da, monopropylene glycol, dipropylene glycol, tripropylene glycol, polypropylene glycols with a molecular weight comprised between 200 and 4,000 Da, propylene glycol methyl ether and isomers thereof, dipropylene glycol methyl ether and isomers thereof, tripropylene glycol methyl ether and isomers thereof, diethylene glycol monoethyl ether, diethylene glycol dimethyl ether, triethylene glycol dimethyl ether, methyl diglycol, methyl triglycol, butyl glycol, butyl diglycol and butyl polyglycol;
(b) adding to the mixture obtained in step (a): (i) one or more dispersants selected from the group consisting of: polyacrylate polymers and derivatives thereof with a molecular weight comprised between 1000 and 100,000 Da, polyurethane polymers and derivatives thereof, acrylate/maleate copolymers and derivatives thereof with a molecular weight comprised between 1000 and 100,000 Da, resins based on styrene/maleic anhydride (SMA), alkylene polyphosphone esters, phosphoric acid esters, salts of carboxylic or hydrocarboxylic acids and derivatives thereof, esters of carboxylic or hydrocarboxylic acids and derivatives thereof, amide polyesters and derivatives thereof; (ii) one or more antifoaming surfactants selected from the group consisting of: block copolymers of ethylene oxide/propylene oxide, pure and/or emulsified silanes, pure and/or emulsified siloxanes, pure and/or emulsified fatty acids and esters thereof; and optionally (iii) one or more preservatives/bactericidal agents selected from the group consisting of methylisothiazolinone (MIT) and derivatives thereof, chloromethylisothiazolinone (CIT) and derivatives thereof, benzisothiazolinone (BIT) and derivatives thereof and organic molecules that release formaldehyde;
(c) adding to the mixture obtained in step (b) one or more inorganic pigments, obtaining a dispersion;
(d) milling the inorganic pigments by treating the dispersion obtained in step (c) with a grinding mill;
(e) filtering the dispersion obtained in step (d).

28. Use of a ceramic ink according to claim 16 to decorate a ceramic article by inkjet printing.

29. The use according to claim 28, wherein said ceramic article is selected from the group consisting of tiles, kitchenware and technical ceramics.

30. A ceramic article decorated with a ceramic ink according to claim 16.
